(19) United States
(12) Patent Application Publication
(10) Pub. No.: US 2006/0029760 A1
(43) Pub. Date: Feb. 9, 2006

(54) Laser film composed of an at least one-ply backing layer comprising a transparent sheet coated on one side with a self-adhesive mass

(75) Inventors: Christian Kreft, Hamburg (DE); Soren Kahlcke, Hamburg (DE)

Correspondence Address: Norris, McLaughlin & Marcus P.A., 18th Floor, 875 Third Avenue, New York, NY, 10022, US

(73) Assignee: tesa Aktiengesellschaft, Hamburg (DE)

(21) Appl. No.: 11/154,923

(22) Filed: Jun. 16, 2005

(30) Foreign Application Priority Data
Aug. 9, 2004 (DE) 10 2004 038 774.5

(51) Int. Cl. B32B 33/00

(52) U.S. Cl. 428/40.1

(57) ABSTRACT

A laser film composed of a) an at least one-ply backing layer comprising a transparent sheet b) coated on one side with a self-adhesive mass c) comprising an additive that changes color under laser irradiation, and d) lined if desired with a release paper or a release film.

The invention relates to a laser film composed of an at least one-ply backing layer comprising a transparent sheet coated on one side with a self-adhesive mass, and to its use on packaging or on articles for transportation.

The inscription and labeling of materials by means of laser is a widespread method. During the inscription process, material is ablated from the material to be inscribed. Where a thin, different-colored top layer is ablated from a base layer, high-contrast inscriptions can be obtained.

DE 81 30 861 U discloses a multilayer label of this kind, comprising a thin and a thick, self-supporting, opaquely pigmented varnish layer. Both layers are composed of a solventlessly applied and electron-beam-cured varnish, the layer thicknesses being different. The label is inscribed by using a laser to burn away the upper, thinner varnish layer, so that the lower, thicker varnish layer becomes visible, said lower layer preferably being of a contrasting color to the first layer.

This inscription is a kind of gravure, thereby ruling out possibilities for manipulation as exist with traditional imprints using inks. As a result of the raw materials used and the production operation, the label is rendered so brittle that its removal from the substrates to which it is adhered is almost always impossible without destruction.

EP 0 645 747 A specifies a laser-inscribable, multilayer label material composed of a first layer and of a second layer which is visually different from the first layer, said first layer being removable by means of laser radiation in accordance with a desired text image or print image, in the course of which the surface of the second layer is rendered visible. Disposed between the layers, furthermore, is a transparent polymeric sheet which forms a carrier layer.

DE 44 21 865 A1 specifies a monolayer laser label comprising a backing layer made of plastic, said layer comprising an additive which changes color under laser irradiation.

The backing layer is coated on one side with a self-adhesive mass, which where appropriate is lined with a release paper or release sheet.

The backing layer is composed of a varnish, in particular a cured varnish, preferably a radiation-cured varnish, and especially an electron-beam-cured polyurethane acrylate varnish. In an alternative embodiment the backing layer is composed of a polybutylene terephthalate.

DE 199 09 723 A1 disclosed a security film having a backing layer in which there is an identification medium. By means of a contactless inscription operation it is possible selectively and locally to alter the diffusion properties of this identification medium in a specific way. When the security film thus inscribed is adhered to a workpiece, the identification medium diffuses toward the surface of the substrate, where it brings about a detectable reaction. This diffusion or reaction takes place only in those regions of the substrate surface in which the operation of inscription has initiated, or has not hindered, the diffusibility. Accordingly the security film allows unambiguous inscription and identification of the workpiece.

The security film is inscribed by means of a contactless method. Thus it is possible to achieve an inscription which is rapid, can be varied flexibly and is insensitive to dirt even in a plant environment. The inscribing of the security film—and hence the alteration of the diffusion properties of the identification medium—may take place in particular by means of electromagnetic radiation. To inscribe the security film it is particularly advantageous to use a laser which allows both temperature-sensitive and light-sensitive inscription (as used here, “light” embraces the entire range of the electromagnetic spectrum that is available to the laser). Lasers have the further advantage of enabling high-contrast inscriptions with a free choice of pattern, of allowing rapid changes to the pattern inscribed, and of operational reliability in use in the plant environment.

An additional security aspect is disclosed in DE 199 04 823 A1. There, a method is described of producing a sheet, said method involving first the embossing of a support sheet by means of an embossing tool, said embossing tool exhibiting holographic structures. Subsequently a sheet is produced on the embossed support sheet, so that at least one hologram is imaged on the sheet.

DE 195 31 332 A1 discloses a laser-inscribable rubber blend. The base material used for this rubber blend is a rubber, preferably a natural rubber, admixed with an additive which changes color under laser irradiation. The rubber may additionally have been blended with customary additives such as antidegradants, crosslinkers, light stabilizers, antiozonants, carbon black, zinc oxide, fatty acids, resins, plasticizers or accelerators.

Suitable additives for producing the color change are, in particular, color pigments and metal salts, especially copper hydroxide phosphate or else Iriodin. These additives are added to the rubber in a quantitative order of 0.1% to 10% by weight, in particular 0.5% to 5% by weight. In addition it is also possible to admix titanium dioxide to the additive as well.

In all of the possibilities stated an inscription is generated in the backing layer of the adhesive tape or label.

Powerful, controllable lasers for burning marks such as indicia, codes, and the like are widespread. Requirements imposed on the material to be inscribed include the following:

It should be rapidly inscribable.

A high spatial resolution should be achieved.

It should be extremely simple to use.

The decomposition products should not be corrosive.

Furthermore, for particular cases, additional property features are called for:

High temperature resistance, to more than 200° C. for example.

Desirable, effective resistance to weathering, water, and solvents.

Known materials employed for this purpose, such as printed paper, eloxed aluminum, coated sheet metal or PVC films, do not meet all of these requirements.

It is an object of the invention to provide a self-adhesive laser film whose inscription after laser treatment is optimally protected and which does not display the disadvantages of the prior art.

This object is achieved by means of a laser film as described by the main claim. The subclaims provide particularly advantageous embodiments of the subject-matter of the invention and also particularly advantageous uses of the laser film of the invention.

The invention accordingly provides a laser film composed of

an at least one-ply backing layer comprising a transparent sheet

coated on one side with a self-adhesive mass

comprising an additive that changes color under laser irradiation, and

lined if desired with a release paper or a release film.

In a first advantageous embodiment the backing layer is composed of a PET or PP sheet. With further preference the backing layer has a thickness of 10 to 200 μm, in particular from 50 to 100 μm.

The backing layer may also be formed from a multi-ply laminate of different sheets, in which case each individual sheet must be transparent.

In accordance with the invention the laser-sensitive additive which generates a change of color under laser irradiation is present in the adhesive. Besides the property of laser inscribability, the adhesive features, in particular, the properties of a pressure-sensitive adhesive.

The adhesive preferably has a light color.

The properties of the adhesive are guided by the requirements of the applications typical for laser films and/or for labels manufactured from them.

The base used for the adhesive is a rubber, natural rubber for example, or a blend of natural rubbers with synthetic rubbers. The absorber pigment responsible for the color change is admixed to this rubber or rubber blend. Moreover, the rubber may have been blended with customary additives such as fillers, antidegradants, crosslinkers, color pigments, zinc oxide or resins.

For setting further properties in the adhesive it is possible for crosslinking to be carried out by means of UV radiation, electron-beam curing, thermally or chemically.

The adhesive layer in one further preferred embodiment has a thickness of 15 to 200 μm, in particular from 30 to 100 μm.

The absorber pigments used to produce the color change are, in particular, color pigments or metal salts, especially copper hydroxide phosphate.

This additive is added to the adhesive in a quantity of the order of 0.1% to 10% by weight, in particular 0.5% to 5% by weight, based on the overall weight of the adhesive.

In accordance with the invention the term “laser film” embraces an adhesive tape, which may have been wound into an Archimedean spiral, and also embraces laser labels or sections which are cut off in lengths from the adhesive in accordance with the specific utility. The laser labels/sections may also be diecut.

The advantages of the film or label with laser-inscribable adhesive are to be seen in the possibility of providing adhesive bonds, where necessary, with individually selectable inscriptions, which are legible permanently and with very good contrast. In comparison to adhesive tapes printed on the backing side, the advantage of a mechanically protected inscription is provided; in other words, as a result of this construction, the advantage arises of protection against loss of information, since in comparison to inscriptions made by an imprinting method the text lies not on the top face of the backing but rather underneath it.

Laser inscription has the further advantage, in comparison to conventional printing systems such as thermal transfer printing, for example, that the flexibility of inscription (progressive serial numbering, short-time changeover from plain text to barcode or the like) is much greater.

One particularly advantageous use of the label of the invention is in the packaging and printing of parcels or of goods for transportation, for dispatch or in the logistics sector.

In the goods packaging sector the label, inscribed or uninscribed, is applied mechanically or manually to the packaging unit. Inscription may take place before or after application. In the advantageous configuration of an inscribable label, an individual inscription—for example, addresses or control codes—is bonded on the packaging unit, and there is no need for any separate bonding operation with a barcode label or address label.

The adhesive can be inscribed using solid-state Nd-YAG lasers, particularly in the case of a light wavelength of 1064 nm. A desired inscription can be produced in the adhesive using electrically controlled deflection systems or else masks.

At the point where the laser impinges on the surface of the material, the additive embedded in the adhesive, such as preferred copper hydroxide phosphate, absorbs the energy. This produces a sharp evolution of heat in the immediate vicinity of the irradiated particle, as a result of absorption of the high-energy radiation, and so the adjacent polymer matrix is carbonized. The adhesive, which preferably is of primarily light coloration as a result of the admixture of titanium dioxide, changes its color in the region of the carbonization that has occurred, as a function of the amount of energy employed, to form shades which are gray to black. This color change generates high-contrast inscriptions.

In the course of inscription the backing film of the tape remains unchanged and the color change in the adhesive takes place with minimal material ablation or none at all.

Advantageously, the laser-inscribable film allows new applications to be covered. In one preferred utility, through the use of sheet backings of high tensile strength, in combination with laser-inscribable adhesive, adhesive bonds in the packaging sector are provided with an additional inscription possibility, or other temporary or permanent bonds of all kinds are provided.

The solutions known to date for the bonding/bonded closure and inscription of a product envisage at least two adhesive applications used alongside one another: firstly, an adhesive tape which ensures the adhesive bonding, and secondly a label with imprinted data such as, for example, addresses, controlled barcodes, etc.

The invention described here combines these adhesive applications with one another: that is, the invention describes a film which at one and the same time ensures the adhesive bond and offers the possibility of carrying out inscriptions thereon.

The purpose of the text below is to illustrate the invention with reference to an example and to two figures, without any intention thereby to restrict the invention in any way whatsoever.

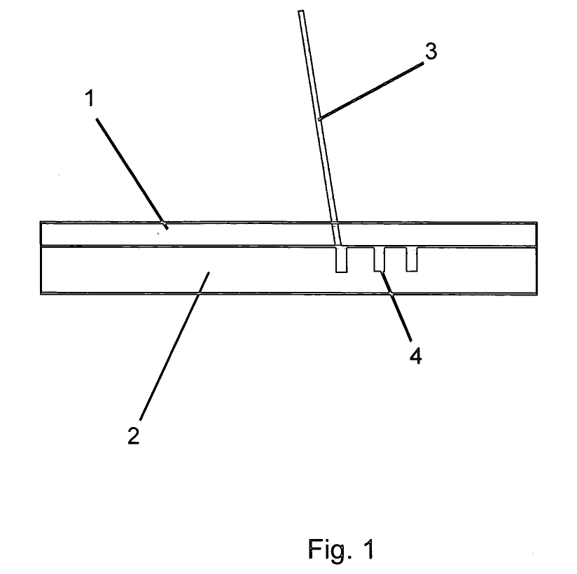

FIG. 1 shows a laser film, which is composed of a backing layer 1, in this caes a transparent 40 μm PET sheet, applied to which there is an adhesive 2.

The laser film is irradiated at the desired points with an Nd-YAG laser 3. The beam 3 passes through the transparent sheet 1 and is absorbed by the additive in the adhesive 2, leading to carbonization of the immediate vicinity 4. At the end of irradiation, the carbonized material produces the desired inscription.

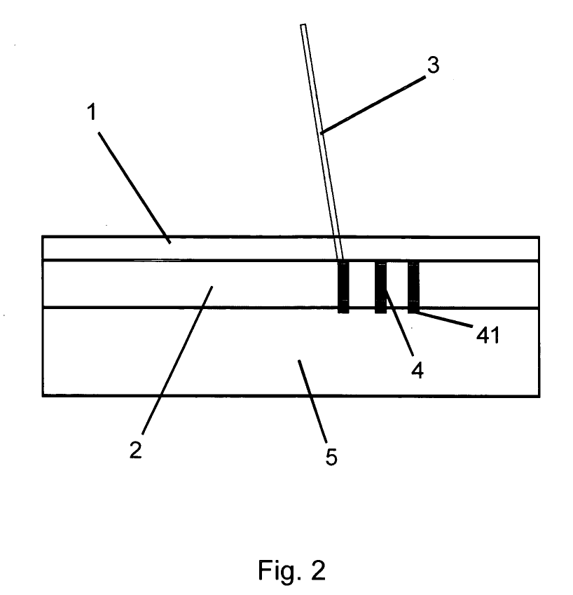

FIG. 2 depicts one particularly advantageous use of the laser film. The laser film is bonded to a substrate 5. The film is inscribed by the adhesive 2 becoming carbonized at the point of impingement of the laser beam 3 over the entire thickness of the layer. Moreover, the beam 3 is guided in such a way that the surface of the substrate 5 is likewise altered/inscribed by the laser beam 3. In the substrate 5 an image 41 appears of the inscription in the laser film.

If the laser film was removed from the substrate 5, this attempted manipulation would be immediately visible, since the inscription 41 in the substrate 5 is no longer covered by the laser film.

The laser film of the invention hence also includes the option of being used as a security label.

### EXAMPLE

Composition of the laser-inscribable adhesive

| | % by weight |
|---|---|
| Natural rubber | 42.40 |
| Chalk | 10.10 |
| C₅-fractionated aliphatic hydrocarbon resin | 39.40 |
| ZnO | 5.10 |
| Titanium dioxide | 1.00 |
| Copper hydroxide phosphate | 1.00 |
| Antidegradant | 1.00 |
| Total | 100.00 |

The adhesive is prepared batchwise in two steps: preparation of a premix, and the final mixture.

### Premixing

The amount of elastomer (natural rubber), filler, zinc oxide, titanium dioxide, antidegradant and copper hydroxide phosphate corresponding to the overall formula, plus about ¼ of the total amount of tackifying resin (C₅-fractionated aliphatic hydrocarbon resin, Piccotac 1100EE from Eastman), are weighed out in accurate gram amounts for the following steps and are charged to a compounder (internal mixer) of the Werner & Pfleiderer type, which is characterized by interengaging screws with a maximum speed of 50 rpm.

The kneading time amounts to 3 minutes at a kneading temperature of 95° C.

### Final Mixing

Subsequently the premix is taken from the compounder and together with the remaining amount of tackifying resin (¾ of the total amount) is transferred to a universal compounder of the type common for rubber-based adhesives.

The premix is kneaded with the tackifying resin for a period of 15 minutes at a kneading temperature of 95° C. The tackifying resin is added in portions at intervals of 4 minutes to the premix which is undergoing kneading.

The adhesive can also be prepared continuously. In that case the requisite ingredients are compounded directly via metering installations, in accordance with the formula, in an extruder process. In this context an appropriate method is one involving a planetary roll extruder.

The adhesive is subsequently shaped to form an adhesive film in a 3-roll coating apparatus. In this case either the backing film is threaded in through the coating slot, which is adjusted so as to give adhesive application rates of 15 to 200 μm, preferably from 30 to 100 μm, or, downstream of the coating slot, the sheet is pressed against the shaped adhesive on the transfer roller, and hence transferred. In both cases the coated backing sheet is wound up to form roll product; where necessary, a liner paper or liner film can be laminated onto the adhesive.

The roll product thus produced can then, if required, be exposed on the adhesive side to UV radiation or to electron beam curing.

### Inscription

The adhesive is inscribed using a solid-state Nd-YAG laser with electrically controlled deflection system.

The parameters can be varied as a function of the laser used and of the desired degree of inscription.

1. A laser film composed of
a) an at least one-ply backing layer comprising a transparent sheet
b) coated on one side with a self-adhesive mass
c) the self-adhesive mass comprising an additive that changes color under laser irradiation, and
d) optionally lined with a release paper or a release film.

2. The laser film as claimed in claim 1, wherein the backing layer is composed of a PET or PP sheet.

3. The laser film as claimed in claim 1, wherein the additive is a color pigment or a metal salt.

4. The laser film as claimed in claim 1, wherein the additive is used in amounts of 0.1% to 10% by weight, based on the total weight of the adhesive.

5. The laser film as claimed in claim 1, wherein titanium dioxide as well as the additive is present in the adhesive.

6. The laser film as claimed in claim 1, wherein the backing layer has a thickness of 10 to 200 μm.

7. The laser film as claimed in claim 1, wherein the adhesive layer has a thickness of 15 to 200 μm.

8. A method of packaging and printing of parcels or of goods for transportation, for dispatch or in the logistics sector, which comprises packaging and printing same with the laser film of claim 1.

9. The laser film of claim 3, wherein said color additive is copper hydroxide phosphate.

10. The laser film of claim 3, wherein said amounts are 0.5% to 5% by weight.

11. The laser film of claim 6, wherein said thickness is from 50 to 100 μm.

12. The laser film of claim 7, wherein said thickness is from 30 to 100 μm.
